(19) United States
(12) Patent Application Publication
(10) Pub. No.: US 2014/0219369 A1
(43) Pub. Date: Aug. 7, 2014

(54) POWER LINE COMMUNICATIONS SIGNAL AGGREGATION AND SWITCH

(71) Applicant: Flextronics AP, LLC, San Jose, CA (US)

(72) Inventor: Christopher P. Ricci, Saratoga, CA (US)

(73) Assignee: Flextronics AP, LLC, San Jose, CA (US)

(21) Appl. No.: 14/174,058

(22) Filed: Feb. 6, 2014

Related U.S. Application Data
(60) Provisional application No. 61/762,044, filed on Feb. 7, 2013.

(51) Int. Cl. H04B 3/54

(52) U.S. Cl. CPC H04B 3/54
USPC 375/257

(57) ABSTRACT

A method, system, and devices are provided that create a network over existing power lines. Two or more modules can establish the network for two or more devices in communication with each other. The modules include components that register device(s) and determine the processing of the data signal being sent over the power line network.

### CROSS REFERENCE TO RELATED APPLICATION

The present application claims the benefits of and priority, under 35 U.S.C. §119(e), to U.S. Provisional Application Ser. No. 61/762,044, filed Feb. 7, 2013, entitled “Power Line Communications Signal Aggregation and Switch,” which is incorporated herein by reference in its entirety for all that it teaches and for all purposes.

### BACKGROUND

Generally, interconnectivity between disparate devices is currently realized via Ethernet or WLAN networks connected to a central server or switch that receives content. This configuration either requires extensive rewiring of existing residences or expertise in configuring wireless topologies (bridges, repeaters)—both of which are generally outside the abilities of the average person.

Moreover, with respect to high bandwidth content, such as streaming video, wireless connectivity does not always provide the quality of service required because of limited bandwidth. Some current power line solutions can enable Ethernet connectivity, but these solutions do not address the problem of requiring a central server or content device to be the source.

### SUMMARY

There is a need for a network topology in current buildings or residences that allows for high bandwidth communication and eliminates the need for a central server or content device. These and other needs are addressed by the various aspects, embodiments, and/or configurations of the present disclosure. Also, while the disclosure is presented in terms of exemplary embodiments, it should be appreciated that aspects of the disclosure can be separately claimed.

The embodiments presented herein can provide a system that utilizes power lines as a transmission media to support, agnostically, (e.g. Ethernet, CableTV, HDMI, Bluetooth) signals on a point to multipoint basis or a point-to-point basis, such that any device within reach of an electrical outlet (typically less than 10 ft) can be a receiver or transmitter on a network. The system may be designed to be a repeater/hub for high bandwidth signals with out-of-band signaling (low bandwidth) signals used to control the distribution of the high bandwidth signals. The signal payload, for the high bandwidth signals, can be encapsulated in a standard for signaling over power lines, for example, the standards established by the HomePlug Powerline Alliance. Calibration and/or compensation for signal dispersion can be done when a new module and/or device is added to a power line network and/or ecosystem, when the network topology changes, or when there is a power-up and/or power-down of the network.

In the power line network, any module and/or device can be a source (providing data for other devices) and/or a sink (consuming data from another device). A controller, that manages the network, can be a standalone device, an application (such as on a smart phone, PC, or laptop), or other hardware and/or software incorporated in a module and/or device on the network.

Embodiments include a network comprising: a power line; a first device; a first receive/send module in communication with the first device and the power line; a second device; a second receive/send module in communication with the second device and the power line; and wherein the first device and second device communicate by send data through the first and second receive/send modules and over the power line.

An aspect of the above network includes wherein the first device is a mobile device.

An aspect of the above network includes wherein the first device is connected to at least one of the Internet and an external device.

An aspect of the above network includes wherein first and second receive/send module comprise: a modulator/multiplexer to receive and send a signal over the power line; a power line encoder/decoder to encode or decode the signal; a digital switch to send at least a portion of data in the encoded or decoded signal to an output; and two or more outputs, wherein each output supplies the portion of data to the first or second device.

An aspect of the above network includes wherein first and second receive/send module further comprise: a transceiver to send or receive a control signal; an out-of-band decoder to encode or decode the control signal; a controller to control the receive/send module based on the control signal; and a switch logic to change the function of the digital switch based on the control signal.

An aspect of the above network includes wherein the outputs are one of a video output, an Ethernet output, a digital audio output, and a universal serial bus output.

An aspect of the above network includes wherein the outputs include a driver and a port.

An aspect of the above network includes wherein the signal includes one or more of: a control signal; a device identifier; a payload; a packet identifier; and a synchronization code.

Embodiments also include a receive/send module comprising: a modulator/multiplexer operable to: demodulate a received signal received over a power line; de-multiplex the demodulated signal; multiplex one or more received signals; modulate the multiplexed signal; a power line encoder/decoder operable to: decode the de-multiplexed signal; encode at least one of the one or more received signals; a digital switch operable to: send at least a portion of data in the decoded signal to an output; and receive digital from the output to packetize for the power line encoder/decoder.

An aspect of the above receive/send module includes further comprising: a transceiver operable to: send a control signal; receive a control signal; an out-of-band decoder operable to: encode the control signal; decode the control signal; a controller operable to: control the receive/send module based on the control signal; generate a control signal to control a different receive/send module; and a switch logic operable to change the function of the digital switch based on the control signal.

An aspect of the above receive/send module includes wherein the outputs are one of a video output, an Ethernet output, a digital audio output, and a universal serial bus output.

An aspect of the above receive/send module includes wherein the outputs include a driver and a port.

An aspect of the above receive/send module includes wherein the signal includes one or more of: a control signal; a device identifier; a payload; a packet identifier; and a synchronization code.

Embodiments include a method for communicating over a power line network comprising: receiving, at a first receive/send module, a registration request for a second receive/send module; the first receive/send module registering the second receive/send module; the first receive/send module sending a control signal to the second receive/send module to instruct processing of a data signal; and the first receive/send module modifying the data signal processing to include data for the second receive/send module.

An aspect of the above method includes further comprising sending a second control signal to a third receive/send module to change a processing of the data signal.

An aspect of the above method includes further comprising: first receive/send module receiving data from an output; and the first receive/send module communicating the data signal over the power line.

An aspect of the above method includes further comprising a second receive/send module receiving the data signal from the first receive/send module.

An aspect of the above method includes wherein communicating the data signal over the power line comprises: switching the received data; encoding the switched data; multiplexing the encoded data; and modulating the multiplexed data onto the power line.

An aspect of the above method includes wherein receiving the data signal from the first receive/send module comprises: demodulating the data signal received on the power line; de-multiplexing the demodulated data; decoding the de-multiplexed data; switching the decoded data; and sending the switched data to an output.

An aspect of the above method includes wherein the data signal included one or more of: a control signal; a device identifier; a payload; a packet identifier; and a synchronization code.

The present disclosure can provide a number of advantages depending on the particular aspect, embodiment, and/or configuration. The network may be formed in existing buildings without needing to establish a wireless network or build a new wired network infrastructure. The network can be constructed without a central server that provides connection services to extranet resources. These and other advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage and/or transmission medium that participate in providing instructions to a processor for execution. Such a medium may take many forms, including but not limited to, non-volatile media and/or volatile media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The term “media” or “multimedia,” as used herein, refers to content that may assume one of a combination of different content forms. Multimedia can include one or more of, but is not limited to, text, audio, still images, animation, video, or interactivity content forms.

The term “module,” as used herein, refers to any known or later developed hardware, software, firmware, artificial intelligence, fuzzy logic, or combination of hardware and software that is capable of performing the functionality associated with that element.

The terms “determine,” “calculate”, and “compute,” and variations thereof, as used herein, are used interchangeably and include any type of methodology, process, mathematical operation or technique.

The term “electronic address” or “identifier” can refer to any contactable address, including a telephone number, instant message handle, e-mail address, Universal Resource Locator (URL), Universal Resource Identifier (URI), Address of Record (AOR), electronic alias in a database, like addresses, and combinations thereof.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram of an embodiment of a power line network;

FIG. 2 is a block diagram of an embodiment of a module for establishing devices on a power line network;

FIG. 3A is a block diagram of an embodiment of a signal transmission or data structure that may be sent, received, or stored on the power line network;

FIG. 3B is a block diagram of an embodiment of a signal transmission or data structure that may be sent, received, or stored on the power line network;

FIG. 4 is a process or flow diagram of an embodiment of a method for establishing a device on a power line network;

FIG. 5 is a process or flow diagram of an embodiment of a method for communicating data over a power line network.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Presented herein are embodiments of a power line network and a module and/or device to establish the power line network. The power line network may be formed by the communication between two or more modules connected to the power lines in a home or building. The modules can include one or more hardware and/or software components that enable the communication of data. Any device connected to a module may receive or send data over the power line network. As such, the network may be data type agnostic and enable communications without a separate server and/or a wired or wireless network. The overall design and functionality of the modules provides for an easily-established and useful communication network.

Power Line Network:

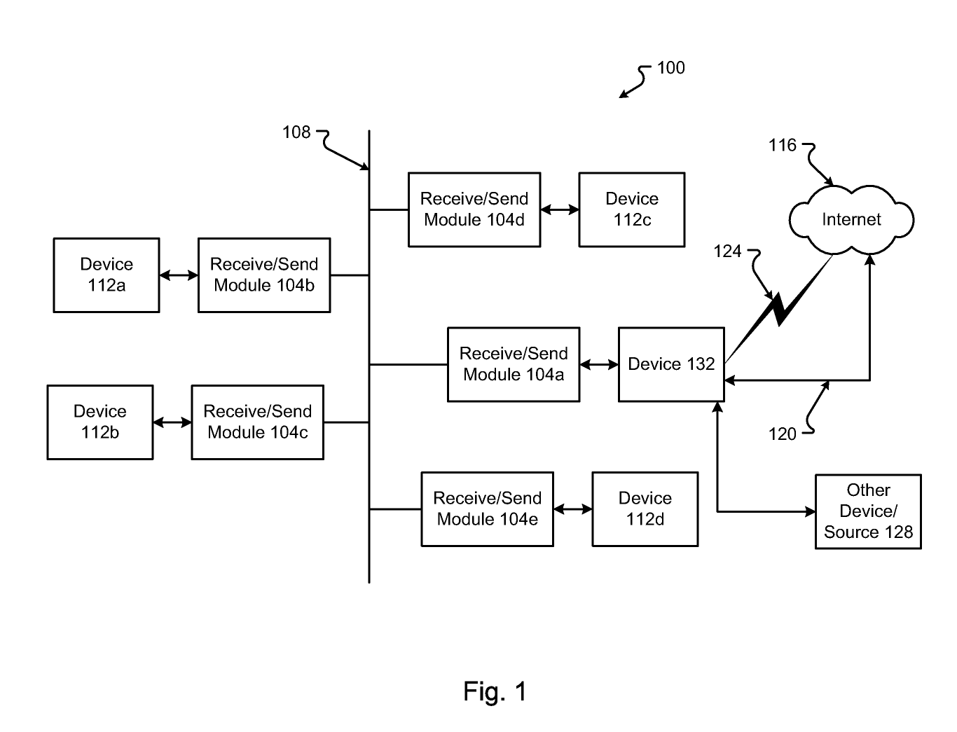

Referring to FIG. 1, a power line network 100 is shown. It is anticipated that the power line network 100 may be used for entertainment, business applications, social interaction, content creation and/or consumption, and to organize and control one or more other devices that are in communication with the power line network 100. As can be appreciated, the power line network 100 can be used to construct a data communication network whether at home or at work.

The power line network 100 may be configured to enable communication between two or more devices 112a-112d, 132. The devices 112a-112d, 132 can be any type of electronic device (i.e., a computing system or device that may have a processor and/or memory) that may generate or consume data and can include hardware, software, or hardware and software. For example, the devices 112a-112d, 132 may include mobile devices, set top boxes, televisions, digital video recorders, gaming systems, computers, etc. The devices 112a-112d, 132 can be connected to the power line network 100 through a receive/send module 104a through 104e.

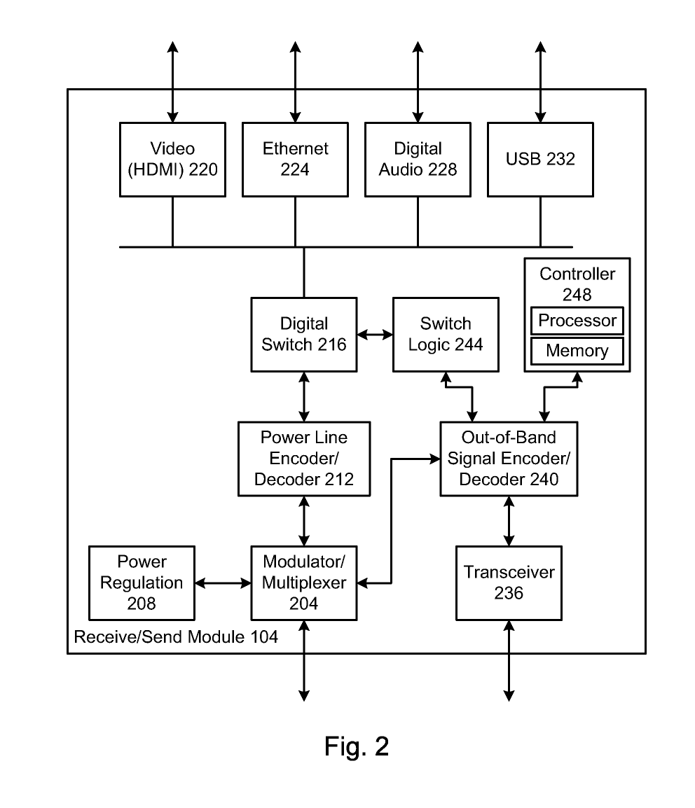

The receive/send module 104a through 104e can include any device, hardware, software, or hardware and software that can connect a device 112, 132 to the power line network 100 and/or allow the device 112, 132 to send or receive data over the power line network 100. An example of a module 104 is described in connection with FIG. 2. The module 104 may be electrically connected to the power lines 108 of a building. The power lines 108 can be an electrical conduit that provides power (e.g., in the United States, the power lines providing 110 v, 60 Hz or 220 v, 60 Hz alternating current power) to a building. The power lines 108 can be also used for the transmission of data using different frequencies or data bands. Thus, the modules 104 can provide data transmission and reception over the power lines and may also provide power to the devices 112, 132.

The devices 112 may function as consumers or sinks for data. In other words, the devices 112 may receive data from other devices 112 or from device 132. The devices 112 may also communicate or send data to other devices 112 or 132. However, the devices 112 may not communicate data to outside devices, networks, or entities. Rather, device 132 may be configured, for example, to communicate with the Internet 116 or other devices/sources 128 that are not part of the power line network 100. The device 132 thus can function as a source of data from external sources. To communicate with the Internet 116 or other devices/sources 128, the device 132 may include hardware, software, or hardware and software to establish wireless communication 124 or wired communication 120 with the Internet 116 or other devices/sources 128. In one example, the device 132 is a mobile device that can communicate with the Internet 116 or other devices/sources 128 using cellular, 802.11-enabled, Bluetooth, or other communication system(s) or protocol(s). The other devices/sources 128 can be another device not connected to the power line network 100. Thus, the device 132 may provide data to or receive data from the Internet 116 or other devices/sources 128.

Receive/Send Module:

FIG. 2 illustrates components of the receive/send module 104. In general, as shown by FIG. 2, the receive/send module 104 can include one or more components or modules, which may be hardware, software, firmware, or a combination thereof. The receive/send module 104 can include a modulator/multiplexer 204, a power regulation module 208, a power line encoder/decoder 212, a digital switch, 216, one or more outputs, which may include, but are not limited to, a video output 220, an Ethernet output 224, a digital audio output 228, and/or a universal serial bus (USB) output 232. The receive/send module 104 can also include a transceiver 236, an out-of-band signal decoder/encoder 240, a switch logic module 244, and/or a controller 248.

The modulator/multiplexer 204 can multiplex the out-of-band signals control signals) with the payload data. Other signals may also be multiplexed. The modulator/multiplexer 204 can also modulate the multiplexed signal onto the power line alternating current signal or may use another type of modulation to send the signal over the power line 108. Further, the modulator/multiplexer 204 may demodulate a received signal and de-multiplex the demodulated signal. As such, the modulator/multiplexer 204 can be any combination of hardware, software, firmware, etc., that may perform these functions. The power signal may be sent to the power regulation module 208. The out-of-band signal may be communicated to the out-of-band signal encoder/decoder 204, and the payload signal may be communicated to the power line encoder/decoder 212.

Power can be supplied to the components of the receive/send module 104 and/or to the device 112, 132 connected to the receive/send module 104 by a power regulation module 208. The power regulation module 208 can, for example, include an AC to DC converter, power control logic, and/or ports for interconnecting the device 112, 132 to the source of power provided on the power line 108.

In support of connectivity functions or capabilities, a power line encoder/decoder 212 can include a module for encoding/decoding and/or compression/decompression for receiving and managing digital information. The power line encoder/decoder 212 enables compression/decompression and/or encoding/decoding of digital information dispatched by or provided to a modulator/multiplexer 204. The decoded digital information may be sent to a digital switch 216, and the encoded digital information may be sent to the modulator/multiplexer 204. Any encoding/decoding and compression/decompression may be performable on the basis of power line standards. The power line encoder/decoder 212 may also encrypt information, which enables the confidentiality of all the data received or transmitted by the user or supplier.

A digital switch 216 includes any hardware and/or software that can route the payload data from and to an output source 220-232. As such, the digital switch 216 can provide or receive digital information from one or more of the video output 220, the Ethernet output 224, the digital audio output 228, and/or the USB output 232. Further, the digital switch 212 can include logic that may be controlled by the switch logic module 244. The logic in the digital switch 212 can adjust what data is sent to each output. Thus, one portion of a received digital information payload may be sent to first predetermined output, while another portion of the received digital information payload may be sent to a second predetermined output.

An output 220-232 can include drivers and any associated ports that may be included to support communications over wired networks or links, for example with other communication peripheral devices. Examples of outputs 220-232 include an Ethernet output, a Universal Serial Bus (USB) output, Thunderbolt™ or Light Peak interface, Institute of Electrical and Electronics Engineers (IEEE) 1394 output, High Definition Multimedia Interface (HDMI) outputs, digital audio outputs, or other interfaces and outputs.

A digital audio output 228 can be included to provide audio to an interconnected speaker or other device, to a stereo receiver, etc. and to receive audio input from a connected microphone or other device. As an example, the digital audio output 228 may comprise an associated amplifier and analog-to-digital converter.

A port interface may also be included with the outputs 220, 224, 228, 232. The port interface may include proprietary or universal ports to support the interconnection of the device 112, 132 to the receive/send module 104. In addition to supporting an exchange of communication signals between the device 112, 132 and the receive/send module 104, the port and/or port interface can support the supply of power to or from the device 112, 132. The port interface may also comprise an intelligent element that comprises a docking module for controlling communications or other interactions between the power line network 100 and a connected device or component 112, 132. The docking module may interface with software applications that allow for the exchange of data with software associated with the device 112, 132 (e.g., media centers, media players, and computer systems).

In support of out-of-band signal communications functions or capabilities, the power line network 100 can include a transceiver 236. The out-of-band signal communications can include the control signals needed to register devices, control packet logic, etc. As examples, the transceiver 236 can comprise wireless components, for example, a GSM, CDMA, FDMA and/or analog cellular telephony transceiver capable of supporting voice, multimedia and/or data transfers over a cellular network. Alternatively or in addition, the receive/send module 104 can include an alternative or additional wireless communications transceiver 236. As examples, the other wireless communications transceiver 236 can comprise a Wi-Fi, Bluetooth™, WiMax, infrared, or other wireless communications link. The transceiver 236 can each be associated with a shared or a dedicated antenna and a shared or dedicated input/output. The transceiver 236 may also include any wired connections.

For out-of-band communications, an out-of-band signal encoder/decoder 240 can include a module for encoding/decoding and/or compression/decompression for receiving and managing control information. The power line encoder/decoder 212 enables compression/decompression and/or encoding/decoding of control information dispatched by or provided to a modulator/multiplexer 204 or to a transceiver 236. The decoded control information may be sent to a controller 248 or a switch logic module 244, and the encoded control information may be sent to the modulator/multiplexer 204 or the transceiver 236. Any encoding/decoding and compression/decompression may be performable on the basis of power line standards or other communication protocols or standards. The out-of-band signal encoder/decoder 240 may also encrypt information, which enables the confidentiality of all the data received or transmitted by the user or supplier.

The controller 248 may comprise a general purpose programmable processor and any necessary memory for executing application programming or instructions. The processor of the controller 248 may include multiple processor cores, and/or implement multiple virtual processors. The controller 248 may include multiple physical processors. As a particular example, the controller 248 may comprise a specially configured application specific integrated circuit (ASIC) or other integrated circuit, a digital signal processor, a controller, a hardwired electronic or logic circuit, a programmable logic device or gate array, a special purpose computer, or the like. The controller 248 generally functions to run programming code or instructions implementing various functions of the power line network 100.

A controller 248 may also include memory for use with the execution of application programming or instructions by the controller 248, and for the temporary or long term storage of program instructions and/or data. As examples, the memory may comprise RAM, DRAM, SDRAM, or other solid state memory. Alternatively or in addition, data storage may be provided. Like the memory, the data storage may comprise a solid state memory device or devices. Alternatively or in addition, the data storage may comprise a hard disk drive or other random access memory.

A switch logic module 244 can include a processor and memory to control the operation of the digital switch 216. Here, the switching of digital information between outputs may be based on the payload structure of the digital signal. Thus, the digital switch 216 is configured to provide the correct data from the digital signal to the correct output. The switch logic module 244 controls the configuration.

Data Structures:

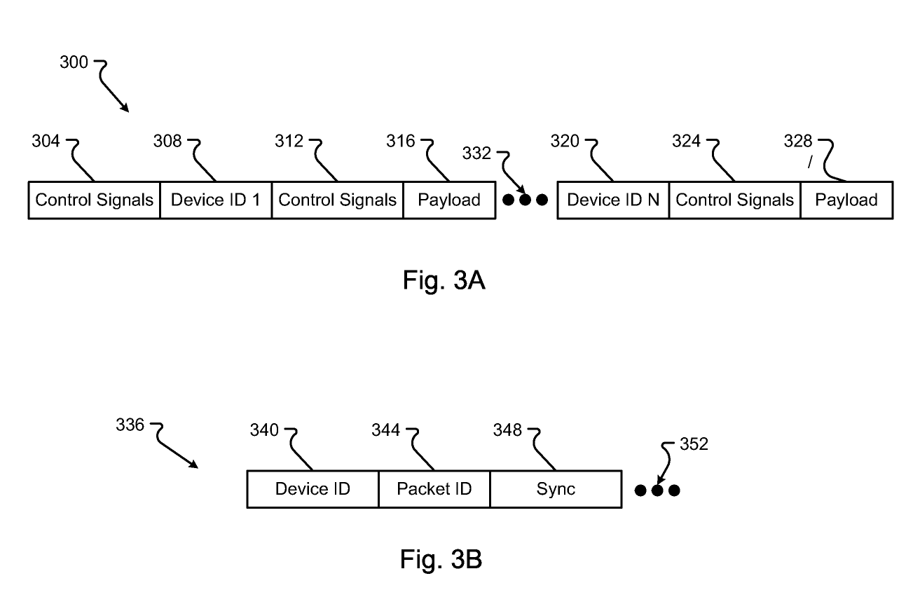

The data structure 300 can include one or more portions of data. The data portions can include control signals 304, a first device identifier 308, payload control signals 312, payload data 316, a device N identifier 320, packet N control signals 324, and/or packet N payload data 328. Further, there may be more or fewer portions of data than those shown in FIG. 3A, as represented by ellipses 332. The data in the data structure 300 may be sent, received, and/or stored by the receive/send modules 104. Generally, the data structure 300 includes the digital data being sent over the power line network 100.

The control signals 304 portion can include any signal used to receive or send the data. The control signals 304 can include information about synchronization of the digital signal, which portion of the data packet is addressed for each of the receive/send module9s0 104, which portion of the payload data 316, 328 is for each output 220-232, information on controlling the switching logic, etc. This control information allows the receive/send module 104 to communicate on the power line network 100.

The device identifier (ID) 308, 320 can be any type of identifier that provides a way of identifying the device 112, 132. The device ID 308, 320 can be an alphanumeric identifier, a globally unique identifier (GUID), or some other identifier that uniquely identifies the device 112, 132 or the receive/send module 104 amongst other devices 112, 132 or receive/send modules 104 on the power line network 100. The device ID 308, 320 may be established when the device 112, 132 or receive/send module 104 initially registers with the power line network 100 and may be communicated to the receive/send module 104 in the control signals 304.

The payload control signals 312, 324 can include any information about how to process the signal received or sent from the receive/send module 104. Thus, the digital information that forms the payload is either destined for an output or received by an output. The payload control signals 312, 324 describe how that digital information should be processed by the digital switch 216 and/or the power line encoder/decoder 212. The control signals 304 can include information about synchronization of the digital signal, which portion of the payload data 316, 328 is for which output, information on controlling the switching logic, etc. This control information allows the receive/send module 104 to provide the payload data to outputs.

The payload data may be provided in field 316, 328. Here, the payload data is the digital information for or from the outputs 220-232. The payload data 316, 328 can be data in any format or governed by any protocol and may be associated with a particular output 220-232. For example, the digital audio output 228 may have digital audio information in the payload data 316, 328. The data sent over the power line network 100 may, thus, be data type agnostic.

The data structure 336, shown in FIG. 3B, can include one or more portions of data associated with the control signals 304, 312 received by the modulator/multiplexer 204 or the transceiver 236. The data portions can include a first device identifier 340, a packet identifier 344, a synchronization code 348, or other portions. Further, there may be more or fewer portions of data than those shown in FIG. 3B, as represented by ellipses 352. The data in the data structure 336 may be sent, received, and/or stored by the receive/send modules 104. Generally, the data structure 336 includes the out-of-band control data being sent over the power line network 100 or with the transceiver 236.

The device identifier (ID) 340 can be any type of identifier that provides a way of identifying the device 112, 132. The device ID 340 can be an alphanumeric identifier, a globally unique identifier (GUID), or some other identifier that uniquely identifies the device 112, 132 or the receive/send module 104 amongst other devices 112, 132 or receive/send modules 104 on the power line network 100. The device ID 340 may be established when the device 112, 132 or receive/send module 104 initially registers with the power line network 100 and may be communicated to the receive/send module 104 in the control signals 304, 336. The device ID 340 is provided to ascertain to which receive/send modules 104 the control signals pertain.

The packet identifier (ID) 340 can be any type of identifier that provides a way of identifying a payload packet 316, 328. The packet ID 340 can be an alphanumeric identifier, a globally unique identifier (GUID), or some other identifier that uniquely identifies the payload packet 316, 328 amongst other payload packet 316, 328 on the power line network 100. The packet ID 340 may be predetermined and set for a certain type of data from a certain source and bound for a certain output. The packet ID 340 is provided to ascertain to which payload packet 316, 328 the control signals pertain.

A synchronization signal 348 can provide a synchronization code that allows a receive/send modules 104 to sync with a packet 300 and begin to receive data. Other control signals in packet 336 can include which packet is to be received by the receive/send modules 104 for a particular output and the sync signal 348 for the packet 300 or for the payload 316, 328. Other control signals are contemplated that would ensure the function of the receive/send modules 104.

Processes:

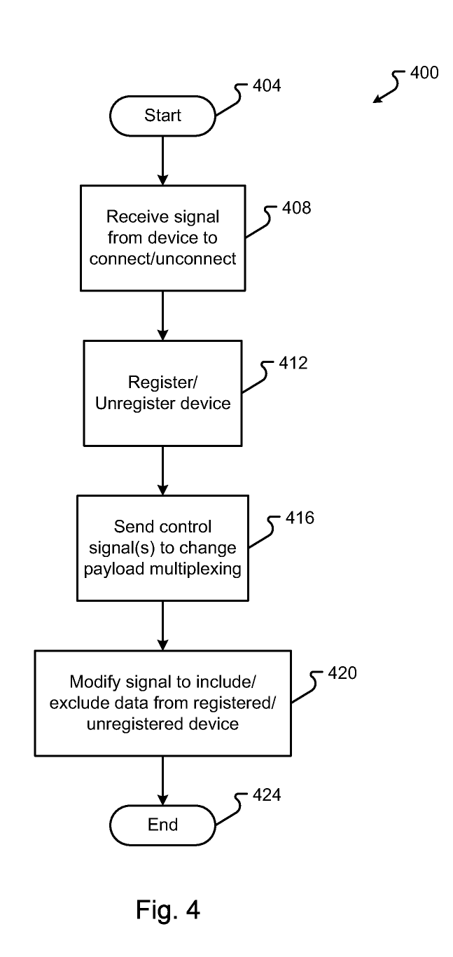

An embodiment of a method 400 for establishing a power line network 100 is shown in FIG. 4. Generally, the method 400 begins with a start operation 404 and terminates with an end operation 424. While a general order for the steps of the method 400 are shown in FIG. 4, the method 400 can include more or fewer steps or arrange the order of the steps differently than those shown in FIG. 4. The method 400 can be executed as a set of computer-executable instructions, executed by a computer system, and encoded or stored on a computer readable medium. Further, the method 400 can be executed by a gate or other hardware device or component in an Application Specific Integrated Circuit, a Field Programmable Gate Array, or other type of hardware device. Hereinafter, the method 400 shall be explained with reference to the systems, components, modules, software, data structures, etc. described herein.

The receive/send modules 104 receives a signal from a device 112, 132 to connect to the power line network 100, in step 408. Generally, a first device 132 may interface with a first receive/send modules 104. The first receive/send modules 104 can await a connection of one or more other devices 112 through one or more other receive/send modules 104. In alternative situations, the first device to connect will be device 112.

When a new device 112a-112d connects, the receive/send modules 104b-e can send a control signal 336, 304 to the receive/send module 104a. The sent signal may include a request to join or register with the power line network 10. The receive/send modules 104a can receive the signal at the modulator/multiplexer 204 or the transceiver 236. This registration signal may be predetermined and have a particular format. The out-of-band signal encoder/decoder 240 can decode the registration signal and send the registration signal to the controller 248. Per predetermined rules, the controller 248 can recognize and understand the registration signal. The controller 248 may extract information from the registration signal including a device description, type of data, bandwidth requirements, or other possible information. Information about the device 112 and or the receive/send modules 104b-e may be stored in memory of the controller 248. The controller 248 can then create and store a device ID 308, 340.

To complete the registration, the controller 248 may send the device ID 308, 340, any packet ID 344, a sync code 348, or other information to the out-of-band signal encoder/decoder 240 to encode the signal for the modulator/multiplexer 204 or the transceiver 236, in step 412. This control signal 304, 336 may then be sent back to the requesting receive/send module 104b-e, which can be received, eventually, at the controller 248 of that receive/send module 104b-e to be stored and processed by the modulator/multiplexer 204 and/or digital switch 216 and switch logic 244.

To un-connect from the power line network 100, the controller 248 of the receive/send module 104a may receive a disconnect signal. As with the registration signals, the disconnect signal may be processed and the information in the signal may be stored or responded to by the controller 248. In other situations, the controller 248 of the receive/send module 104a may monitor a signal, e.g., a polling signal in the control signal 304, 336, or other information to determine if one or more of the receive/send modules 104b-e have been disconnected. If there is an indication that a receive/send modules 104b-e has been disconnected, the controller 248 can understand the disconnect as a request to un-connect the receive/send module 104b-e.

Regardless of whether the receive/send module 104b-e is requiring a connect or un-connect, the controller 248 can send one or more control signals 304, 336 to change the payload configuration and/or multiplexing, in step 416. The control signals 304, 312, and/or 324 can provide information about which payload packet is associated with each of the receive/send modules 104a-e to allow the receive/send modules 104a-e to properly de-multiplex the signal 300. Thus, the modulator/multiplexer 204 can receive controls from the controller 248 to de-multiplex or multiplex the incoming or outgoing signal to extract or send the payload 316 328 at the appropriate place in the signal 300. The control signal may be further processed by the digital switch 216, which can be controlled by the switch logic 244 based on the control signals 304, 312, and/or 324. As such, the receive/send modules 104a-e receive or send signals 300 over the power line network and modify those signals 300, in step 420, based on the controls signals received above to provide or receive data from the registered device 112 or to discontinue the provision of data to an unregistered device 112.

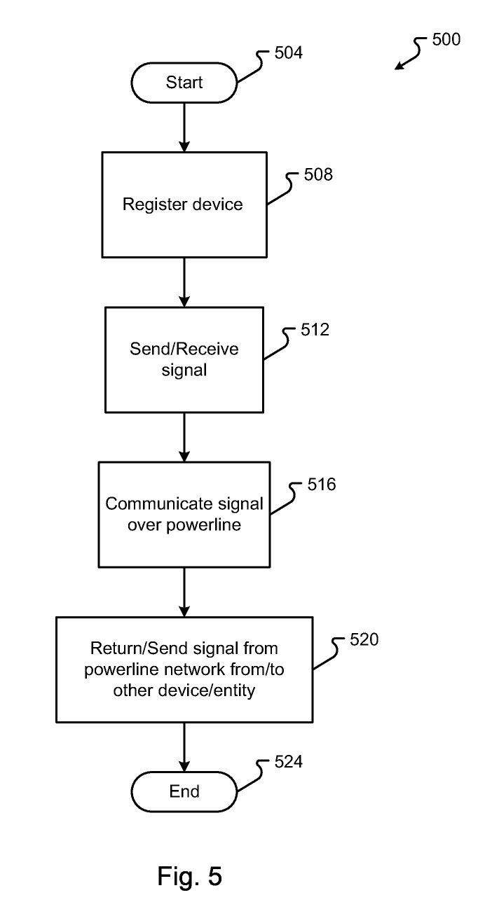

An embodiment of a method 500 for communicating data over a power line network 100 is shown in FIG. 5. Generally, the method 500 begins with a start operation 504 and terminates with an end operation 524. While a general order for the steps of the method 500 are shown in FIG. 5, the method 500 can include more or fewer steps or arrange the order of the steps differently than those shown in FIG. 5. The method 500 can be executed as a set of computer-executable instructions, executed by a computer system, and encoded or stored on a computer readable medium. Further, the method 500 can be executed by a gate or other hardware device or component in an Application Specific Integrated Circuit, a Field Programmable Gate Array, or other type of hardware device. Hereinafter, the method 500 shall be explained with reference to the systems, components, modules, software, data structures, etc. described herein.

A device 112, 132 registers with the power line network 100, in step 508. The registration process may be as described in conjunction with FIG. 4. The device 112, 132 may then send and/or receive signals 300, 336, in step 512. To send data, the device 112, 132 provides data to an output 220-232, which provides the data to a digital switch 216 of the receive/send module 104. The digital switch 216 provides the data to the power line encoder/decoder 212 at a position within the payload 316, 328 reflective of when the data should be inserted and encapsulated. The power line encoder/decoder 212 encodes the data, which is provided to the modulator/multiplexer 204. The modulator/multiplexer 204 multiplexes the encoded data with any other data from the out-of-band signal encoder/decoder 240 or power regulation 208. The modulator/multiplexer 204 then modulates the data and transmits the data over the power lines 108, in step 516.

The recipient of the signal, which may be another receive/send module 104b-e or receive/send module 104a, may then return or send a signal back to the sender, including data from a device 112, 132, the Internet 116, or other device 128, in step 520. The returned signal may be received and processed in reverse order to what is described above.

The described system and methods provide several advantages. First, the network may be formed from existing power lines without the need for new infrastructure or configuring a wireless network. Further, there is no need for a central server or network router/switch. Rather, a single device, such as a mobile device, may act as a portal to the Internet or external resources. This configuration eliminates unneeded equipment and makes the network topology simpler and easier to maintain.

The exemplary systems and methods of this disclosure have been described in relation to power line infrastructures. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a network. It will be appreciated from the preceding description, and for reasons of computational efficiency, that the components of the system can be arranged at any location within a distributed network of components without affecting the operation of the system. Similarly, one or more functional portions of the system could be distributed between a device(s).

Furthermore, it should be appreciated that some of the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

The systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Further, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

The disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A network, comprising:
a power line;
a first device;
a first receive/send module in communication with the first device and the power line;
a second device;
a second receive/send module in communication with the second device and the power line; and
wherein the first device and second device communicate by sending data through the first and second receive/send modules and over the power line.

2. The network of claim 1, wherein the first device is a mobile device.

3. The network of claim 2, wherein the first device is connected to at least one of the Internet and an external device.

4. The network of claim 3, wherein the first and second receive/send module comprise:
a modulator/multiplexer to receive and send a signal over the power line;
a power line encoder/decoder to encode or decode the signal;
a digital switch to send at least a portion of data in the encoded or decoded signal to an output; and
two or more outputs, wherein each output supplies the portion of data to the first or second device.

5. The network of claim 4, wherein first and second receive/send module further comprise:
a transceiver to send or receive a control signal;
an out-of-band encoder/decoder to encode or decode the control signal;
a controller to control the receive/send module based on the control signal; and
a switch logic to change the function of the digital switch based on the control signal.

6. The network of claim 5, wherein the outputs are one of a video output, an Ethernet output, a digital audio output, and a universal serial bus output.

7. The network of claim 6, wherein the outputs include a driver and a port.

8. The network of claim 7, wherein the signal includes one or more of:
a control signal;
a device identifier;
a payload;
a packet identifier; and
a synchronization code.

9. A receive/send module, comprising:
a modulator/multiplexer operable to:
demodulate a received signal received over a power line;
de-multiplex the demodulated signal;
multiplex one or more received signals;
modulate the multiplexed signal;
a power line encoder/decoder operable to:
decode the de-multiplexed signal;
encode at least one of the one or more received signals;
a digital switch operable to:
send at least a portion of data in the decoded signal to an output; and
receive digital data from the output to packetize for the power line encoder/decoder.

10. The receive/send module of claim 9, further comprising:
a transceiver operable to:
send a control signal;
receive a control signal;
an out-of-band encoder/decoder operable to:
encode the control signal;
decode the control signal;
a controller operable to:
control the receive/send module based on the control signal;
generate a control signal to control a different receive/send module; and
a switch logic operable to change the function of the digital switch based on the control signal.

11. The receive/send module of claim 5, wherein the outputs are one of a video output, an Ethernet output, a digital audio output, and a universal serial bus output.

12. The receive/send module of claim 6, wherein the outputs include a driver and a port.

13. The receive/send module of claim 7, wherein the signal includes one or more of:
a control signal;
a device identifier;
a payload;
a packet identifier; and
a synchronization code.

14. A method for communicating over a power line network comprising:
receiving, at a first receive/send module, a registration request for a second receive/send module;
the first receive/send module registering the second receive/send module;
the first receive/send module sending a control signal to the second receive/send module to instruct processing of a data signal; and
the first receive/send module modifying the data signal processing to include data for the second receive/send module.

15. The method of claim 14, further comprising sending a second control signal to a third receive/send module to change a processing of the data signal.

16. The method of claim 15, further comprising:
the first receive/send module receiving data from an output; and
the first receive/send module communicating the data signal over the power line.

17. The method of claim 16, further comprising a second receive/send module receiving the data signal from the first receive/send module.

18. The method of claim 17, wherein communicating the data signal over the power line comprises:
switching the received data;
encoding the switched data;
multiplexing the encoded data; and
modulating the multiplexed data onto the power line.

19. The method of claim 18, wherein receiving the data signal from the first receive/send module comprises:
demodulating the data signal received on the power line;
de-multiplexing the demodulated data;
decoding the de-multiplexed data;
switching the decoded data; and
sending the switched data to an output.

20. The method of claim 19, wherein the data signal includes one or more of:
a control signal;
a device identifier;
a payload;
a packet identifier; and
a synchronization code.
